(19) United States
(12) Patent Application Publication
(10) Pub. No.: US 2010/0252160 A1
(43) Pub. Date: Oct. 7, 2010

(54) Wheel hub connection-free tire traction device

(75) Inventors: Debra L. Gelowicz, Beaverton, OR (US); Patrick D. Boyd, Aloha, OR (US)

Correspondence Address: ATER WYNNE LLP, 1331 NW Lovejoy St. Suite 900, PORTLAND, OR, 97209-2785, US

(73) Assignee: Debra L. Gelowicz

(21) Appl. No.: 12/384,416

(22) Filed: Apr. 3, 2009

(51) Int. Cl. B60C 27/00

(52) U.S. Cl. 152/213 R

(57) ABSTRACT

A clamshell tire traction device having two or more grip portions operatively couple-able by a fastening mechanism is described. The device grips the peripheral tread region of the tire without requiring any contact or connection with the wheel or its hub. The grips are equipped with spaced-apart radial cleat-bearing arms that extend around the tread region and toward the interior of the tire. The fastening mechanism includes a tensioning mechanism that is easily and quickly operated manually by a pivotal lever and includes a release mechanism operable by a depressible pushbutton.

### FIELD OF THE INVENTION

The invention relates generally to the field of vehicle tire traction. More particularly, the invention relates to traction devices for placement on the tires of vehicles for improved traction in ice, snow, or other slick conditions.

### BACKGROUND OF THE INVENTION

Conventional tire traction devices include heavy chains and lighter weight chain substitutes such as cables all made of dense metal or metal alloys. These devices generally have opposing connection means such as cables residing on the interior and exterior of the tire. Radially spaced-apart traction means extend between the opposing connection means and over the outer tread region of the tire. The traction means typically are chain link segments or cable segments mounting traction cleats.

Conventional tire traction devices are notoriously difficult and time-consuming to install and remove. The driver typically must get out of the vehicle, and then must place a pair of these devices on the ground adjacent to the drive wheels and in alignment with the vehicle, and then must drive carefully onto the approximate center of the length of the devices, and then must bring the free ends of the devices together around the tires, and then must connect the free ends to one another, and then must tension the chains to render them taught around the tires. To remove these devices, the driver must get out of the vehicle and then execute the installation process steps in reverse order. Metal is very cold to the touch in cold weather. Moreover, cold or glove-encumbered hands are often not nimble enough readily to perform the required installation and removal steps. Storage of relatively heavy metal tire chains or chain substitutes is haphazard, and frustrating and time-consuming tangles often result.

Recent advances in chain substitutes (“cable chains”) permit them to be installed without laying them out flat and driving onto them. Instead these cable chains are draped over and around the tire and secured first on the inside of the tire with a contiguous cable length and then partly tightened on the outside of the tire by threading a strap through a loop and affixing a rubber catch. But these cable chains must be tightened after the vehicle is driven a short distance to prevent them from being ineffective or, worse, ‘thrown’ off the tire.

Recently, a Swiss company introduced the SPIKES SPIDER™ tire traction product featuring a relatively lightweight and more open design purportedly quicker and easier to install and remove. The product has a central circular portion from which plural arms radially and inwardly (toward the vehicle's central axis) extend, the circular portion requiring attachment when needed to a wheel hub-mounted steel base plate member that must be seasonally installed and removed using a tool such as a lug wrench. Moreover, the number and placement of lug nuts on wheels and hubs of different manufacture make a universal solution impossible, since different hub-mounted base members are required, so the proposed SPIDER™ solution at best is hit and miss. Finally, while lightweight and durable, perhaps, this prior art product requires more manual effort and tools to produce a temporal modification to the wheels' hubs before the tire- and road-engaging traction device can be used. Such is virtually useless in an out-of-season or otherwise un-contemplated emergency such as a freak snow, mountain climb, or ice flow. This is because of its wheel-hub-attached base plate installation and removal requirement, which effectively connects the product intimately not only with the vehicle's tire but also with the vehicle's wheel.

### BRIEF DESCRIPTION OF THE DRAWINGS

FIG. 1 is a front elevation of the tire traction device during an early phase of the installation process therefor relative to a vehicle tire, in accordance with one embodiment of the invention.

FIG. 2 is a front elevation corresponding with FIG. 1 but showing a later phase of the installation process wherein the two halves of the device have been brought together and tensioned relative the vehicle tire.

FIG. 3 is an isometric exploded assembly drawing of the tire traction device, showing the latching mechanism that enables tensioning and durable capture of the tire (not shown in this view) by the device.

FIG. 4 is a fragmentary cross-sectional view taken along lines 4-4 in FIG. 2.

FIGS. 5A, 5B, and 5C are fragmentary cross-sectional details illustrating the latching mechanism of FIG. 3 in accordance with one embodiment of the invention. Specifically, FIG. 5A shows a ratchet-and-pawl mechanism in use to tension the halves of the device tightly to embrace the tire (not shown in these figures); FIG. 5B shows the ratchet-and-pawl mechanism locked in place; and FIG. 5C shows the ratchet-and-pawl mechanism with a quick-release pushbutton connected with the pawl depressed thus to release the tension and quickly to remove the device from around the tire's circular perimeter.

### DETAILED DESCRIPTION OF THE PREFERRED EMBODIMENTS

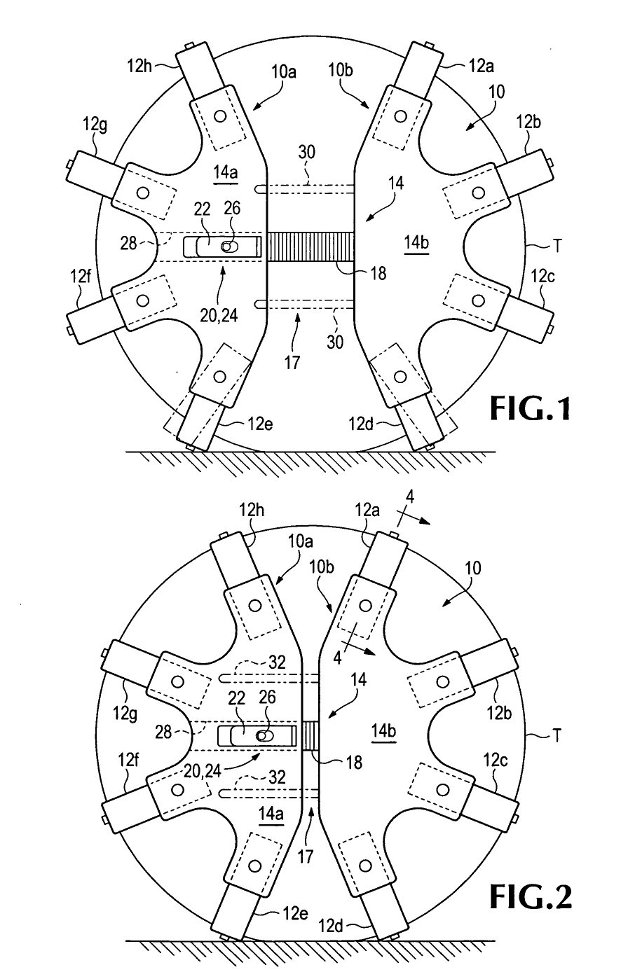

FIGS. 1 and 2 are front elevations of tire traction device 10 during an early and later phase of the installation process therefor relative to a vehicle tire T, in accordance with one embodiment of the invention. Device 10 includes plural (e.g. two) opposing grips such as nearly mirror-image and symmetric halves 10a and 10b, as may be seen. Halves 10a and 10b will be understood by those of skill in the art to be separable but may be left in one piece at all times, rendering device 10 integral and easy to install, to remove, and to stow in a vehicle trunk. Alternatively, halves 10a and 10b may be separated from one another, one of them reoriented 180°, nested one within the other, and stowed in a more compact space within a vehicle's trunk. Those of skill also will appreciate that halves 10a and 10b are equipped with radial arms and cooperative connecting or latching members of any suitable form that enable them to be manually brought together, aligned in opposition with one another, engaged with one another, and tensioned toward one another, such that device 10 tightly and fixedly ‘embraces' the perimeter of tire T.

Device 10 includes plural (e.g. eight) radial arms 12a, 12b, . . . 12h that extend radially outwardly from a central brace 14 that, in accordance to one embodiment of the invention is provided in two halves 14a and 14b. Arms 12a, 12b, . . . 12h extend not only radially but also inwardly (toward the vehicle's central axis) and then ultimately slightly radially inwardly (toward the tire's central axis perpendicular to the vehicle's central axis) generally to conform with the road-proximate perimeter of tire T, as may be seen better by brief reference to FIG. 4. Those of skill in the art will appreciate that arms 12a, 12b, . . . 12h can extend radially and adjustably (fixably with a screw, for example, along a slotted hole not shown) from brace 14 such that they ‘reach’ the perimeter of tire T of whatever nominal diameter. Alternatively, and within the spirit and scope of the invention, arms 12a, 12b, . . . 12h can extend radially and fixedly from brace 14 such that they are dimensioned to correspond directly with a given nominal tire diameter, and, of course, in this case device 10 can come in different sizes to accommodate most or all nominal tire sizes. Arms 12a, 12b, . . . 12h also can be rendered removable and replaceable, within the spirit and scope of the invention.

Those of skill in the art will appreciate that different numbers and configurations of brace members and arms are contemplated. For example, symmetry and durability can be achieved alternatively by providing three brace members each mounting three arms, the three radially evenly spaced-apart brace members being nearly identical and being affixed together in a central region by a similar latching mechanism, with the nine substantially evenly radially spaced-apart arms embracing the tire. Thus, the invented device is broadly defined as including two or more opposing tire grips coupled with a connection mechanism for rigidly connecting the two or more opposing grips together. Opposing will be understood not to imply only a 180° opposition, since a 120° or another (partial) oppositional angle is contemplated in alternative embodiments of the invention. All such alternative embodiments are within the spirit and scope of the invention, although for simplicity and durability it is believed that the bi-lateral brace member and arm arrangement described and illustrated herein is superior.

The invented tire traction device is referred to herein as resembling a clamshell and as being wheel hub connection-free, as no connection whatsoever is required between any part of the tire traction device and the hub of the wheel mounting the tire. This represents a significant improvement in quickly-and-easily installed and removed tire traction devices since no seasonal preparation of the vehicle is required and no instant use of tools to install or remove the traction device is required. Moreover, as will be seen, no reach-around to the interior wall of the tire or blind manipulation of a catch/release mechanism is required to install or remove the clamshell-configured traction device in accordance with the invention.

Those of skill in the art will appreciate that arms 12a, 12b, . . . 12h can extend across the tread region of tire T at an angle that is not perpendicular to the plane of the tire's rotation. Within the spirit and scope of the invention, for example, arms 12a, 12b, . . . 12h can all extend at the same angle such that the distal end of each arm trails the proximal end thereof, thereby increasing the ‘coverage’ and the likelihood that a cleat is in contact with the slick roadway at all times of the tire's rotation. Alternatively and also within the spirit and scope of the invention, alternate arms 12a, 12c, 12e, and 12g can extend at a first common angle and arms 12b, 12d, 12f, and 12h can extend at a second common angle complementary to the first common angle. This last arrangement of angled arms results in what might be described as a zig-zag (or Z-shaped) pattern. Those of skill in the art will appreciate that adjacent arms can join at their distal ends to provide further rigidity in such a configuration.

Those of skill in the art will appreciate that one or more of arms 12a-12h, e.g. adjacent arms 12d and 12e, and/or adjacent arms 12a and 12h, can be slightly pivotally adjustable to increase flexibility in installation and removal of device 10 from tire T and/or to increase size-adjustability to accommodate a slightly oversize tire T. This can be achieved very simply by slightly over-sizing the channels within brace halves 14a and 14b from which the corresponding arms extend, as suggested by the dash-dot outlines of arms 12d and 12e in FIG. 1. Such oversized channels permit the corresponding arms thereof to pivot slightly a few degrees around the pin that affixes them within their channels, as suggested by the dashed lines around arms 12d and 12e. Those of skill will appreciate that, with ice and snow tightly packed underneath tire T, this slight adjustability of arms 12d and 12e (or, alternatively or additionally of arms 12a and 12h so that device is reversible top-to-bottom), the lower ground-adjacent arms, permit wider latitude and ease of installation under such difficult road conditions, as the arms nearest the ground can swing slightly outwardly (fore and aft of where the rubber meets the road) without difficulty.

It will be appreciate by those skilled in the art that, alternatively or additionally to the provision of slight angle-adjustability of some or all of arms 12a-12h, length-adjustability or one or more arms can be provided in accordance with the invention. Such length-adjustability can be provided by a slotted hole formed in one or more arms 12a-12h and a secure-able and/or tighten-able fastener, e.g. a screw, that affixes the length adjustment of the length-adjustable arm(s) within slightly elongated channels of brace halves 14a and 14b. Such would enable one or more of arms 12a-12h to embrace a tire T of greater or lesser diameter than, say, a nominal 15″ diameter. Adjustments to tire diameters ranging, for example, from 14-16″ might be accommodated by such a provision. Those of skill in the art will appreciate that the optional structures described and illustrated herein of angle-adjustability or length- (so-called ‘reach-’) adjustability can be usefully combined to accommodate tires of various sizes so that the arms better reach and tightly and conformingly embrace the round periphery of the tire.

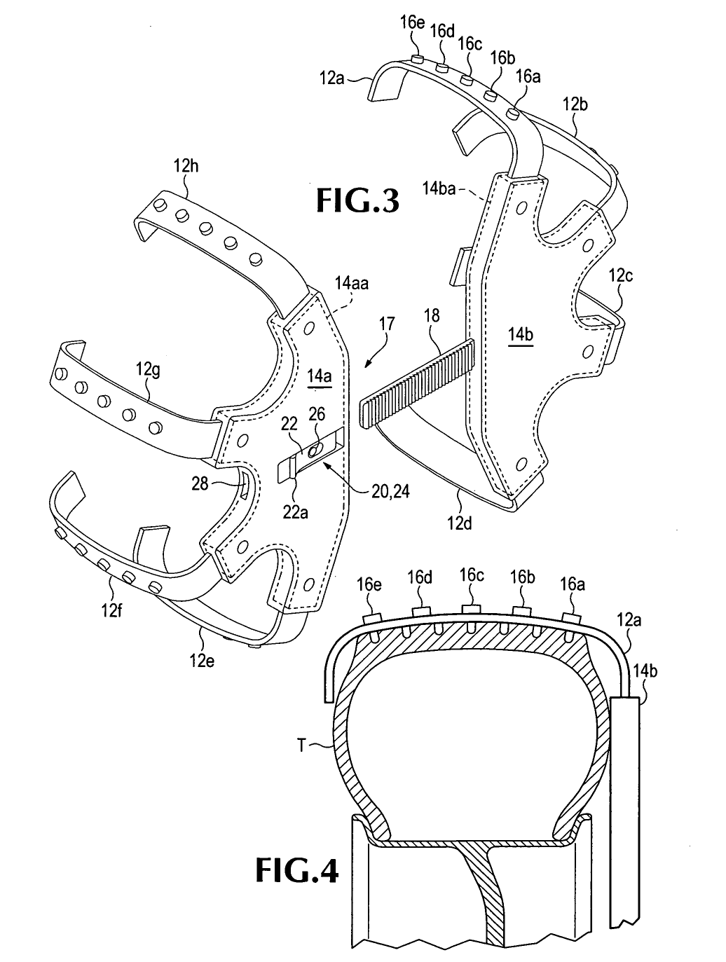

Arms 12a, 12b, . . . 12h are equipped with plural (e.g. five) traction cleats or studs 16a, 16b, . . . 16e, as best shown in FIGS. 3 and 4, that extend along the road-engaging surface of the arms when device 10 is installed on tire T. Cleats or studs 16a, 16b, . . . 16e can be made of tungsten carbide or another durable, wear-resistant material and may be screw-in or otherwise removably installable such that they are removable/replaceable over time or when worn. Such cleats or studs will be understood to extend transversely of the roadway on which the tire travels, thus to provide significant traction in snow, ice, or other slick conditions of the roadway. Those of skill will appreciate that cleats or studs 16a, 16b, . . . 16e can extend through to the inner, tire-tread-engaging surface of arms 12a, 12b, . . . 12h to increase friction and to avoid any undesirable counter-rotation or slipping tendency between device 10 and tire T.

Arms 12a, 12b, . . . 12h in accordance with one embodiment of the invention are made of a rigid, durable, weather-resistant, somewhat resiliently deformable material such as aluminum or titanium or high-density plastic (e.g. somewhat flexible but shape-retentive polyvinylchloride (PVC), high-density polyethylene (HDPE), high-impact polystyrene (HIPS), high-molecular-weight high-density polyethylene (HMWHDPE), ultrahigh-molecular-weight polyethylene (UHMWPE)). Those of skill in the art will appreciate that other suitable materials including but not limited to polymer, plastic, graphite (or otherwise carbon-based), and/or metal (including any suitable alloy) may be used so long as they are suitably rigid and durable to mount the cleats and to provide reliable affixment thereof under stressful conditions of torque, speed, and acceleration. (A durable anti-abrasive and anti-wear and anti-breakdown coating of THERMOLON™ or other similar material can be applied to metal arms. Other anti-abrasive or sunscreen products can be applied to polymer arms to avoid structural weakening and or abrasion from sunlight and salt or other solvents or abrasives (e.g. sand or gravel)).

Those of skill in the art will appreciate that brace 14a and 14b similarly can be made of lightweight but rigid and durable material such as those listed above. Alternatively, brace halves 14a and 14b can include a metal armature or interior for rigidity and a reinforced or high-density plastic outer or exterior. In such a contemplated embodiment, arms 12a-12h preferably are affixed through the less rigid and durable high-density plastic exterior ‘skin’ to the more rigid and durable metal interior ‘skeleton.’ Other configurations and materials are contemplated as being within the spirit and scope of the invention.

Those of skill in the art will also appreciate that the leading and/or trailing edges of the road-confronting regions of arms 12a-12h can be serrated, toothed, corrugated, or otherwise configured thereby further to increase traction beyond that provided by cleats 16a-16e alone. Those of skill also will appreciate that the road-confronting regions of arms 12a-12h alternatively can be configured to criss-cross (X-shaped) or otherwise produce an angled traverse of the tire (whether in a closed zig-zag (Z-shaped) manner or in an open angled manner) whereby adjacent arms and their mounted cleats effectively overlap each other or at least close any gap therebetween to ensure that maximum cleat-to-road traction is available regardless of the rotation of the tire relative to the road. All such alternative configurations of arms and cleats to further increase traction are contemplated as being within the spirit and scope of the invention.

Those of skill in the art further will appreciate that another alternative way further to increase traction beyond that provided by cleats 16a-16e on each of arms 12a-12h involve providing criss-crossing or otherwise angled chains (and/or other elongate coupling members) extending between adjacent arms, from an interior of one to an exterior of the other. Alternatively, chains can be made to extend between adjacent arms in line with the generally parallel, alignment with the travel axis of tire T. Such is believed to provide increased stability against torsional forces acting particularly on the free outer and interior regions of the arms, causing adjacent arms to work better in tandem and in concert with one another to reduce tension therebetween.

In accordance with one embodiment of the invention, arms 12a, 12b, . . . 12h are fixedly mounted to central brace 14, as by adhering (e.g. injection molding and curing or otherwise ‘welding’) and/or pinning and/or riveting. Alternatively, and within the spirit and scope of the invention, arms 12a, 12b, . . . 12h can be integrally molded with brace halves 14a and 14b so that they are unitary therewith and no adhesives or other joints are needed. Those of skill in the art will appreciate that plural arms 12a, 12b, . . . 12h may be of the same, similar, or different material from brace halves 14a and 14b.

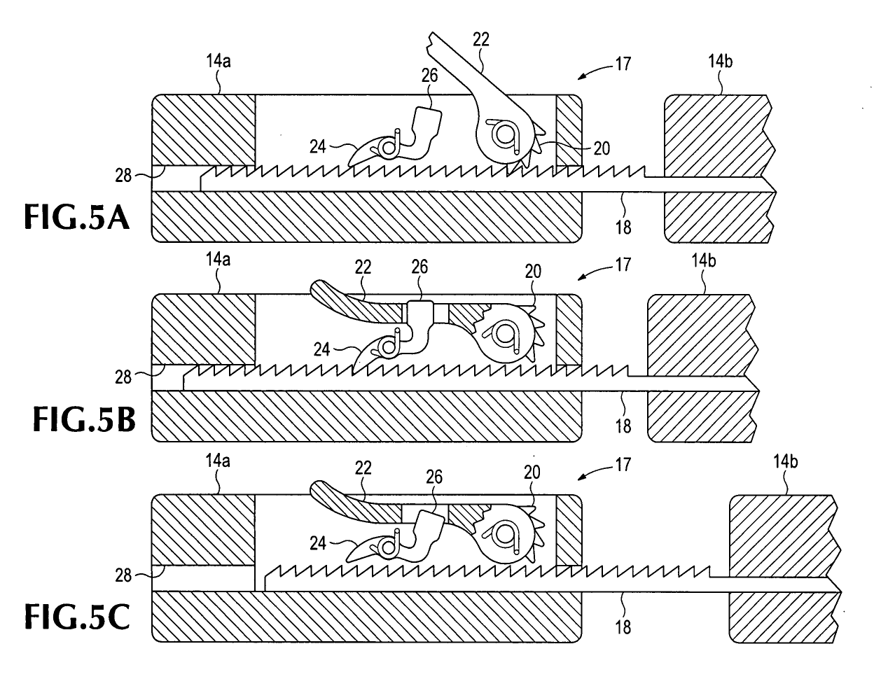

Device 10 includes a connecting or latching mechanism 17 that can take any suitable form configured to permit aligned and durable and tensionable engagement between brace halves 14a and 14b to secure device 10 to tire T. Thus, connecting or latching mechanism 17 will be understood to include a tensioning mechanism for increased gripping of a perimeter of a tire. In accordance with one embodiment of the invention, latching mechanism 17 includes a rack or axial ratchet member 18 including one or more linear stair-stepped surfaces for aligned engagement with a corresponding radial stair-stepped surface of a circular ratchet member 20, as may be best seen by brief reference to FIGS. 5A-5C. Those of skill in the art will appreciate that cooperative ratchet members 18 and 20 are configured selectively to engage one another to produce relative and controlled movement therebetween for manual tensioning of brace halves 14a and 14b together. Latching mechanism 17 can be made of any suitably rigid and durable material such as polymer, graphite, plastic or metal (e.g. aluminum, tungsten carbide, titanium, stainless steel, or the like).

Circular ratchet member 20 is equipped with a lever 22 configured in reciprocal operation to increase tension between the brace halves and a pawl or catch/release arm 24 is equipped with a pushbutton 26 configured in depressed operation to release tension therebetween. Those of skill in the art will appreciate that axial ratchet member 18 can be dimensioned lengthwise to provide any desired ‘throw’ or ‘reach’ such that an optimal tradeoff is achieved between tire size adjustment and quick tensioning tire embrace. Those of skill in the art also will appreciate that lever 22 can be dimensioned lengthwise to provide any desired leverage, with an understanding that more leverage is achieved by a longer lever under basic mechanical advantage principles. Those of skill in the art will appreciate that circular ratchet member 20 including lever 22 and axial ratchet member 18 may be described collectively herein as a manually operable tensioning mechanism.

Those of skill in the art also will appreciate that ratchet members 18 and 20 may be referred to herein as first and second capture members, wherein a first capture member, e.g. ratchet member 20, extends from or within one of the two opposing tire grips and wherein a second capture member, and e.g. ratchet member 18, extends from or within another of the two opposing grip members, wherein the first and second capture members are configured to engage one another to rigidly connect the two or more opposing grips together.

Those skilled in the art will appreciate that pushbutton 26 can be key lockable to increase security against theft and/or subterfuge. Those of skill also will appreciate that device 10 can be serialized (imprinted with a unique serial number that is registered to the proper owner). Finally, those of skill will appreciate that device 10 can be embedded with an identification (ID) code and telemetry chip similar to those subcutaneously planted in pets to provide tracking and recovery options for owners. These and other theft or loss or vandalizing prevention or remedial means and methods are contemplated as being within the spirit and scope of the invention.

Thus, to install device 10 on a tire, halves 10a and 10b of device 10 are brought together in alignment and in vertical orientation with the arms positioned around tire T as shown in FIG. 1 with axial ratchet member 18 in operative engagement with circular ratchet member 20. Lever 22 is reciprocally operated a few times until the desired tension is achieved between brace halves 14a and 14b, and thus until the desired tension is achieved among arms 12a, 12b, . . . 12h and the road-engaging perimeter of tire T, as shown in FIG. 2.

Yes, it is that simple to install invented device 10 on a tire. There is no laying out of chains or cables on the surface of the snow or ice, no untangling and alignment thereof with the vehicles tires; no looping of chain or cable ends over the tire's circumference along the inside and outside thereof, no alignment or insertion of a post in a keyhole slot of the tensioning cable, no tensioning with rubber belts and S clips, no loose parts, no tools, no re-dos. There is no heavy metal or its maddening klunk-klunk noise and potential damage from excess cable or chain link against the wheel well or fender. And no reverse difficulties removing the chain or cable from the tire.

And there is no seasonal requirement that a base plate be mounted to the wheel's hub using a dreaded lug wrench or other difficult-to-locate and -use tool from the trunk or garage.

There is only safety, security, comfort, convenience, quickness, and ease in installing and removing the invented traction device.

Those of skill in the art will appreciate by comparing FIGS. 1 and 2 that, as device halves 10a and 10b are placed over tire T they are moved at least partway toward one another to engage axial ratchet member 18 of brace 14b within an elongate opening 28 of brace 14a. Then lever 22 is operated as many times as needed to produce tension between halves 10a and 10b and to bring arms 12a, 12b, . . . 12h into a tight embrace around tire T. It will be understood that tires within a small range of diameters thus can be accommodated by invented traction device 10 by way of the adjustability of latching mechanism 17.

Those of skill in the art will appreciate that one or more optional alignment pins such as alignment pins 30 (shown in dash-dot lines extending from brace half 14b of FIGS. 1 and 2) and opposing bores 32 (suggested by dash-dot lines extending within brace half 14a of FIGS. 1 and 2) can be provided to pre-align the brace halves as they are brought together around tire T. It will be appreciated that such alignment features can take alternative forms, and can be interchanged left to right, in accordance with the invention. It is believed that such alignment features are not required in all embodiments because of the inherent alignment caused by the introduction of elongate ratchet member 18 of brace half 14b within an opposing elongate opening 28 of brace half 14a (refer briefly to FIG. 3). Those of skill in the art will appreciate that alignment pins 30 and corresponding bores 32 are optionally, but may be more desirably included in embodiments of the invention in which brace 14 is made of less rigid material and/or alignment of its halves 14a and 14b by use of latching mechanism 17 alone for proper and securable alignment is otherwise more difficult.

It will be appreciated that rotational balance is desirable when traction device 10 is secured to rotating tire T to avoid a bumpy ride and/or excessive noise. Thus it is desirable to manufacture device 10 with a stationary or rotating weight balance relative to its physical center. In other words, the center of rotating mass of device 10 preferably is at its structural center that, when device 10 is installed on tire T, is congruent with its center of mass. This is accomplished in accordance with the invention by manufacturing device 10 to relatively tight dimensional and weight tolerances. Those of skill in the art will appreciate that brace 14b, for example, of device 10 may be counterweighted to counterbalance any extra mass that is associated with any extra weight within brace 14a associated with the ratchet-and-pawl or alternative capture portions of latching mechanism 17. Alternative means of properly balancing device 10 for superior performance, e.g. the attachment or repositioning of weights around its periphery, are contemplated as being within the spirit and scope of the invention. (Those of skill will appreciate that it is most desirable that the center of mass of invented device 10 is substantially centered on or congruent with the central axis of rotation of the tire, such that the rotating tire with the invented device affixed thereto provides a static and dynamically balanced rotation.)

Those of skill in the art will appreciate that device 10 can be formed by any suitable process (e.g. injection molding), within the spirit and scope of the invention. Those of skill also will appreciate that device 10 can be made of any color material if desired, whether to complement the color of one's vehicle or to contrast therewith. Designer colors and/or patterns and/or graphics also are contemplated as being within the spirit and scope of the invention. Logos can be added to the outer visible surface of device 10, whether to personalize the device to the vehicle's owner or to identify and promote a manufacturer or sponsor or other individual or entity. Such logos can be applied to device 10 by any suitable process (e.g. dyeing, painting, air-brushing, printing, embossing, bossing, molding, or the like, singly or in combination). Additionally, all or a portion of the exterior ‘skin’ is removable and replaceable in an embodiment, such as to renew and/or alter aesthetic characteristics of device 10.

FIG. 3 is an isometric exploded assembly drawing of the tire traction device, showing latching mechanism 17 that enables tensioning and durable capture of the tire (not shown in this view) by the device. FIG. 3 is believed to be largely self-explanatory in view of the detailed description above by reference to FIGS. 1 and 2. Channel 28 can be seen to extend through brace half 14a thus to receive member 18 therein and perhaps partly therethrough when the halves are brought together during installation of traction device 10. Lever 22 can be seen in one embodiment of the invention to have a finger or thumb-grippable free end 22a that facilitates the gripping thereof even in cold weather or with a gloved hand. Optional metal or more durable and rigid armature halves 14aa and 14ba are shown in dashed outline, as discussed above, that further increase the rigidity and durability of brace 14 and the rigid and secure affixing of arms 12a-h therein.

From FIG. 3, it may be seen that traction cleats 16a-16e arrayed along each of arms 12a-12h illustrated, for the sake of simplicity, as being generally cylindrical. Nonetheless, those skilled in the art will appreciate that, within the spirit and scope of the invention, they can be of any suitable shape, e.g. they can be cylindrical, conical, frusto-conical, pyramidal, and otherwise shaped, curved, pointed, barbed, or serrated on their extreme, ground-contacting ends, or terminated, thereby to increase traction in ice and snow or otherwise low-traction travel conditions.

FIG. 4 is a fragmentary cross-sectional view taken along lines 4-4 in FIG. 2. Those of skill in the art will appreciate from FIGS. 3 and 4 that device 10 somewhat resembles a clamshell that extends primarily around only the outer periphery of, and yet reliably embraces, tire T. In other words, device 10 barely extends along the inner periphery of the tire, as suggested by FIG. 3, and engages the outer region of the tire and hub only along an outer periphery of the tire, as is clear from FIG. 4. Thus, importantly, device 10 does not require engagement or even contact with the hub or rim of tire T or to any other radially inward feature or portion thereof. Instead, because of its clamshell configuration and tire- (rubber-) peripheral attachment means, device 10 extends primarily only across the outer and tread regions of T tire, thus avoiding problematic prior art requirements of wheel-attachment. However, at least one embodiment optionally includes integrally formed and/or attachable and removable members extending partially and/or fully from a proximal side (relative to the vehicle center) of device 10 to engage a portion of T tire and/or a wheel mounting T tire. Such members may be configured and/or useful as stand-offs, vibration dampers, optional additional device 10 securing attachments, device-to-wheel relative rotation prevention members, or other forms or uses, and may be reciprocally configured correspondingly to either specific and/or more general wheel configurations.

FIGS. 5A, 5B, and 5C are fragmentary cross-sectional details illustrating latching mechanism 17 in accordance with one embodiment of the invention. Those of skill in the art will appreciate that alternative configurations of latching mechanism 17 are contemplated as being within the spirit and scope of the invention, and that the illustrated ratchet-and-pawl mechanism shown herein represent only one of many possible configurations for latching halves 14a and 14b of brace 14 securely together and in proper alignment to embrace and provide traction to tire T.

FIGS. 5A-5C illustrate latching mechanism 17 in fragmentary detail, in accordance with one embodiment of the invention. FIGS. 5A-5C are believed to be largely self-explanatory, as ratchet-and-pawl latching mechanisms generally are known to those of skill. FIGS. 5A, 5B, and 5C collectively show latching mechanism 17 configured as a ratchet-and-pawl mechanism respectively in an installation, use, and removal phase of operation in which brace halves 14a and 14b of device 10 are urged together, locked in place, and removed from around the perimeter of a tire.

The ratchet-and-pawl mechanism in accordance with one embodiment of the invention includes opposing, toothed ratchet members 20 and 18 operable by lever 22 to advance member 18 within channel 28, with pivotal ratchet member 20 being mounted for pivoting within a slotted opening including a spring mechanism (e.g. a torsion-producing coil spring) that normally biases or urges its pivotal mounting pin into a position wherein the opposing but complementary teeth are engaged. The ratchet-and-pawl mechanism also includes a catch arm or pawl 24 selectively operable by a manually operable release mechanism including a pushbutton 26 releasably to capture axial ratchet member 18 within channel 28 at a desired relative axial position therebetween, pawl 24 being biased or urged by a second spring mechanism (e.g. a torsion-producing coil spring) nominally into a counter-clock-wise rotational position in which its tooth engages a corresponding tooth of axial ratchet member 18.

When the release mechanism is operated, e.g. when pushbutton 26 is temporarily depressed (see FIGS. 5A and 5C), it will be understood that brace halves 14a and 14b can be urged apart. On the other hand, when the release mechanism is not operated, e.g. pushbutton 26 is not depressed (see FIG. 5B), it will be understood that brace halves 14a and 14b cannot be urged apart. Thus, FIG. 5A represents a ratchet-and-lock phase of use of device 10 in which the device is tightened around the periphery of a tire; FIG. 5B represents a locked-in-place phase of the use of device 10 wherein the device tightly embraces the periphery of the tire; and FIG. 5C represents an unlocked-in-place phase of the use of device 10 wherein the device releases its embrace of the periphery of the tire.

Those of skill in the art will appreciate that connecting or latching mechanism 17 can take alternative forms within the spirit and scope of the invention. For example, lever 22 can take the form of a manually grip-able and rotatable knob instead of a pump lever. Or the latching mechanism can include a fixed-throw (not throw-adjustable) slide-snap-fit-and release configuration including a snap-fit detent and releasable catch member that does not require a ratchet, pawl or lever. Such a latching mechanism may require a hair pin or awl-like or key-like tool (such as can be carried on a keychain) for easy and quick release instead of a pushbutton. Or the latching mechanism can take the form of a rotatable crank handle with a knob and a levered lock mechanism that disables cranking when the handle is in certain positions, like those used in so-called ‘come-alongs’ or hoists. Likewise, latching mechanism can be largely retained within a recess in a brace half (e.g., 14a) when engaged, as best seen in FIGS. 3 and 5B-5C, or can alternatively generally lie exposed at or above a surface thereof. These and all other suitable alternatives are contemplated, and thus are within the spirit and scope of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A wheel-hub-connection-free tire traction device comprising:
two or more opposing tire grips, each grip including plural arms extending radially from a central brace region of the grip, each arm being configured at its distal end to extend around the perimeter of a tire and to confront the same along a tire tread confronting region of the arm and partway around the inside corner of the tire tread;
a connecting mechanism for rigidly connecting the two or more opposing grips to one another such that a perimeter of a tire is securely grippable between the plural arms, the connecting mechanism including one or more first capture members extending from or within one or another of the grips, the connecting mechanism further including one or more second capture members extending within or from the other or the one of the grips, the first and second capture members being configured to engage one another to rigidly connect the two or more opposing grips together.

2. The device of claim 1, wherein the connecting mechanism includes a manually operable tensioning mechanism for increased gripping of a perimeter of a tire.

3. The device of claim 2, wherein the tensioning mechanism includes a ratchet-and-pawl mechanism.

4. The device of claim 3, wherein the ratchet-and-pawl mechanism is operable via a manually operable lever.

5. The device of claim 2, wherein the connecting mechanism further includes an alignment mechanism for aligning the pair of opposing tire grips while the central brace regions are brought into proximity with one another.

6. The device of claim 1, wherein the connecting mechanism includes a manually operable release mechanism for decreased gripping of a perimeter of a tire.

7. The device of claim 6, wherein the release mechanism includes a pushbutton.

8. The device of claim 1, wherein the device is configured not to connect directly with a hub of a wheel mounting a tire.

9. The device of claim 1, wherein the device is configured to connect to a tire substantially only along a perimeter thereof.

10. The device of claim 1, wherein each arm is equipped with plural cleats spaced apart at least along the tire tread confronting region thereof.

11. The device of claim 1, wherein the connecting mechanism includes opposing brace members each securing some of the plural arms.

12. The device of claim 11, wherein each arm is removable from its corresponding brace member.

13. The device of claim 12, wherein each cleat is removable from its corresponding arm, whereby a removed cleat can be replaced.

14. The device of claim 12, wherein each arm is adjustably extendable from its corresponding brace member.

15. The device of claim 1, wherein a center of mass of the device with capture members engaged in use is substantially centered on a central rotating axis of a tire.

16. A tire traction device comprising:
opposing tire brace halves collectively configurable as a tire brace, each brace half including plural arms extending radially therefrom, the arms numbered and configured and spaced apart from one another to substantially embrace the peripheral tire-tread region of a vehicle's tire, each arm mounting an array of plural traction-promoting cleats extending outwardly therefrom for frictional engagement with a tire support surface;
a fastening mechanism between the opposing brace halves, the fastening mechanism manually operable to affix the opposing brace halves together into a brace assembly,
wherein the brace assembly and the plural arms extending therefrom are configured and dimensioned to grip the tire along the peripheral tire-tread region of the tire to promote traction between the tire and the tire support surface during rotation of a wheel mounting the tire without contact between the tire traction device and the wheel.

17. The device of claim 16, wherein the fastening mechanism includes a tensioning mechanism that is manually operable to urge gripping of the tire by the device.

18. The device of claim 17, wherein the tensioning mechanism includes a release mechanism that is manually operable to release gripping of the tire by the device.

19. The device of claim 18, wherein the release mechanism includes a manually operable pushbutton.

20. A tire traction device comprising:
opposing tire brace halves collectively configurable as a tire brace, each brace half including plural arms extending radially therefrom, the arms numbered and configured and spaced apart from one another to substantially embrace the peripheral tire-tread region of a vehicle's tire, each arm mounting an array of plural traction-promoting cleats extending outwardly therefrom for frictional engagement with a tire support surface;
a fastening mechanism between the opposing brace halves, the fastening mechanism manually operable to affix the opposing brace halves together into a brace assembly,
wherein the brace assembly and the plural arms extending therefrom are configured and dimensioned to grip the tire along the peripheral tire-tread region of the tire to promote traction between the tire and the tire support surface during rotation of a wheel mounting the tire without contact between the tire traction device and the wheel,
wherein the fastening mechanism includes a tensioning mechanism that is manually operable to urge gripping of the tire by the device,
wherein the tensioning mechanism includes a release mechanism that is manually operable to release gripping of the tire by the device, and
wherein the release mechanism includes a manually operable pushbutton.
